(19) United States
(12) Patent Application Publication
(10) Pub. No.: US 2015/0310547 A1
(43) Pub. Date: Oct. 29, 2015

(54) TRADING AT INDEX CLOSE

(71) Applicant: Deutsche Börse AG, Eschborn (DE)

(72) Inventor: Tobias Dirk EHINGER, Karben (DE)

(21) Appl. No.: 14/260,239

(22) Filed: Apr. 23, 2014

(51) Int. Cl. G06Q 40/04

(52) U.S. Cl. CPC G06Q 40/04

(57) ABSTRACT

A computer-readable medium is provided which has stored computer-executable instructions that, when executed by a computer, cause the computer to maintain an order book having orders for first futures contracts to determine if a first order for first futures contracts is executable against a side of the order book, wherein an underlying of a first futures contract is a second futures contract and wherein each order of the order book defines a quantity of the first futures contracts and a price of the first futures contracts. The computer-readable medium further has stored computer-executable instructions that, when executed by the computer, cause the computer to determine a delivery price of the second futures contracts based on a spot price associated with the second futures contracts and a determined price of the first futures contracts.

### BACKGROUND OF THE INVENTION

1. Field of the Invention

The invention relates to the field of trading derivatives and, more particularly, to computer systems and computer-implemented methods for trading futures contracts.

2. Description of the Related Art

Derivatives such as futures or options have become increasingly important in the world of finance. Futures and options are now traded actively on many exchanges throughout the world. A derivative is a financial instrument whose value depends on or derives from the values of other, more basic underlying variables. Very often, the variables underlying derivatives are the prices of traded assets. A stock option, for example, is a derivative whose value is dependent on the price of a stock.

A derivative exchange is a market where individuals trade standardized derivatives contracts that have been defined by the exchange. Traditionally, derivatives traders have met on the floor of an exchange and used shouting and complicated sets of hand signals to indicate the trades they would like to carry out. This is known as the open outcry system. However, exchanges have increasingly moved from the open outcry system to electronic trading.

A futures contract (also referred to as futures) is an agreement between two parties to buy or sell an asset (the underlying) at a certain time in the future for a certain price. An underlying of a futures contract may be, for instance, a commodity, a security such as a stock, a bond, a currency or an intangible, such as an interest rate and an index or any other underlying. Futures on currencies, financial securities or on financial indices are also called financial futures.

Trading At Index Close (TAIC) is becoming more important for market participants. Conventionally, a first part of a TAIC trade, i.e. the basis of the TAIC, is agreed by market participants before the close of an index. Trades where two parties agree upon without the supervision of an exchange are called an over the counter (OTC) trade. Market participants may place buy or sell TAIC orders on index futures contracts at any point during the day before the market closes. Upon market close, each party involved transacts in the index futures market with a price determined as being the closing index value plus the basis which has been agreed on by the counter-parties. For instance, a basis of 3 has been agreed and the index close is 1.234.75 index points. The final futures price would be 1.237.75.

TAIC can reduce transaction costs, substitute cash baskets, futurize swaps and reduce tracking errors.

Several exchanges offer technical solutions for trading at index close, such as the Intercontinental Exchange (ICE), the Chicago Mercantile Exchange (CME), and the London International Financial Futures and Options Exchange (LIFFE) US or are in preparation to do so, e.g. the LIFFE. Those solutions focus on an over-the-counter crossing functionality only.

In other state of the art exchange markets, participants can only trade TAIC by splitting each transaction into several pieces to achieve an average price. However, this is limited to trades for which the smallest part of the split trade is meeting an over-the-counter (OTC) block trade size threshold, i.e. the quantity of assets of the smallest part of the split trade is equal to or greater than a minimum quantity of assets (the block trade size threshold) defined by the OTC block trade facility.

Accordingly, a need exists for a trading system and computer-implemented trading method which overcome the limitations of over-the-counter TAIC trading.

### SUMMARY OF THE INVENTION

According to an embodiment, a computer-implemented method executed by one or more computing devices for trading first futures contracts is provided, wherein an underlying of a first futures contract is a second futures contract. An order book having orders for the first futures contracts is opened, wherein each order of the order book defines a quantity of the first futures contracts and a price of the first futures contracts. When a first order for the first futures contracts is received, the order book is accessed to determine if the first order is executable against a side of the order book. The first order defines a first quantity of the first futures contracts and a first price of the first futures contracts. If the first order is not executable, the first order is stored in a side of the order book. If the first order is executable, the first order is executed against a side of the order book, a spot price associated with the second futures contracts is determined, and a delivery price of the second futures contracts is determined. The delivery price is based on the spot price and the first price defined by the executed first order.

According to another embodiment, a system comprising a trading platform is provided. The trading platform has one or more processors and a memory operatively coupled to the one or more processors. The memory stores instructions that, when executed by the one or more processors, cause the one or more processors to open an order book having orders for first futures contracts, wherein an underlying of a first futures contract is a second futures contract and wherein each order of the order book defines a quantity of the first futures contracts and a price of the first futures contracts, to receive a first order for the first futures contracts, wherein the first order defines a first quantity of the first futures contracts and a first price of the first futures contracts, and to access the order book to determine if the first order is executable against a side of the order book. The memory stores further instructions that, when executed by the one or more processors, cause the one or more processors to store the first order in a side of the order book if the first order is not executable and to execute the first order against a side of the order book, to determine a spot price associated with the second futures contracts, and to determine a delivery price of the second futures contracts if the first order is executable. The delivery price is based on the spot price and the first price defined by the executed first order.

According to a further embodiment, a computer-readable medium is provided which has stored computer-executable instructions that, when executed by a computer, cause the computer to maintain an order book having orders for first futures contracts to determine if a first order for first futures contracts is executable against a side of the order book, wherein an underlying of a first futures contract is a second futures contract and wherein each order of the order book defines a quantity of the first futures contracts and a price of the first futures contracts. The computer-readable medium further has stored computer-executable instructions that, when executed by the computer, cause the computer to determine a delivery price of the second futures contracts based on a spot price associated with the second futures contracts and a determined price of the first futures contracts.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1 provides a schematic overview of an order book containing different bid and ask orders prioritized by the limit and entry time according to an embodiment;

FIG. 2 shows a flowchart illustrating a method for trading first futures contracts which have second futures contracts as underlying according to an embodiment;

FIG. 3 shows a computer architecture for a trading system according to an embodiment; and

FIG. 4 shows a computer architecture for a trading system according to an embodiment.

### DETAILED DESCRIPTION OF THE INVENTION

The illustrative embodiments of the present invention will be described with reference to the figure drawings, wherein like elements and structures are indicated by like reference numbers.

The present invention may be operational with numerous general purpose or special purpose computing systems environments or configurations. Examples of well-known computing systems, environments and/or configurations that may be suitable for use with the invention may include, but are not limited to: personal computers, server computers, handheld or laptop devices, multi-processor systems, micro-processor based systems, network PCs, mini computers, tablet computers, smart phones, mainframe computers, distributed computing environments that include any of the above systems or devices, and the like.

The invention may be described in the general context of computer executable instructions, such as program modules, being executed by a computer.

Generally, the present invention provides an order book trading system for trading futures contracts which have other futures contracts as underlying and a method for trading such futures on futures using an order book.

In contrast to existing solutions, the present invention provides order book trading for TAIC products. The order book trading creates a new asset class by trading first futures contracts which have other futures contracts as underlying separately at an exchange. The first futures contracts may be referred to as basis futures contracts or basis futures or basis. This new product type may be called futures on futures with physical settlement of the underlying futures. In contrast to the settlement price concept, the underlying futures are settled individually by adding the traded basis price to the index close price.

A futures contract (also referred to as futures) is a binding obligation enforceable at law to buy or sell a stated quantity of a specified asset (the underlying) on a specified date (delivery date) in the future at a predetermined price. The contracts may be negotiated at a futures exchange, which acts as an intermediary between two parties trading in futures. The party agreeing to buy the underlying asset in the future, the buyer of the contract, is said to be long, and the party agreeing to sell the asset in the future, the seller of the contract, is said to be short. An expiration date of a futures series is the time a futures contract of the series stops trading. There may be several series for futures traded on an exchange. Each series of a futures may be associated with a different expiration date.

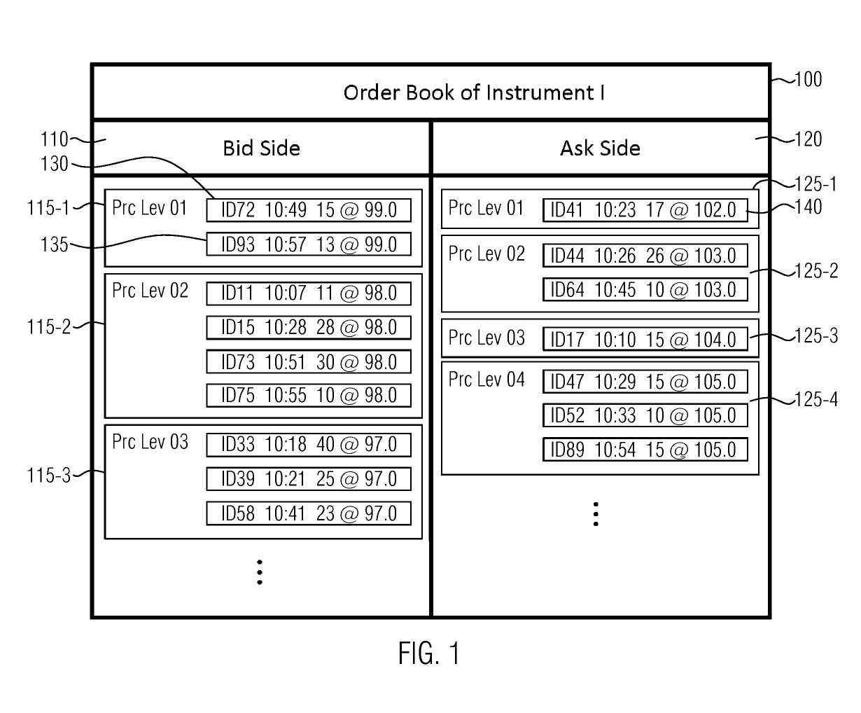

When using an electronic trading system, bid and ask orders of a futures contract may be stored in a corresponding order book. FIG. 1 shows an order book 100 for a financial instrument I according to embodiments of the present invention. The financial instrument may be, for instance, a futures.

An order book is said to be crossed if the best bid price is equal to or greater than the best ask price. During the continuous trading phase of an exchange, in case an incoming order results in a crossed order book, the incoming order needs to be executed immediately against orders stored in the order book side opposite to the incoming order until the crossed order book situation is resolved. Thus, during the continuous trading phase, a crossed order book situation in a futures contract never occurs. The immediate execution of an incoming order against one or several orders stored in the order book is also referred to as matching.

Order books may be stored in electronic trading systems as tables. As illustrated in FIG. 1, one side 110 of an order book 100 of a financial instrument I such as a futures contract, the bid side, may comprise buy orders and the other side 120, the ask side, of this table 100 may comprise sell orders. Discussing order books on the example of futures in more detail, for the bid side 110, contracts of one or more limit orders being associated with the same limit may be merged into one price level. Similarly, for the ask side 120, contracts of one or more limit orders being associated with the same limit may be merged into one price level. Each price level may be associated with a limit. The table 100 may store any number of different price levels.

Generally, for the bid side 110, the best bid, i.e. the highest limit a market participant is willing to pay for a certain volume (also referred to as quantity) of contracts of the futures, may be merged into the top-most price level 115-1. The contracts associated with the lowest limit a market participant is willing to pay for a certain volume of contracts of the futures may be merged into the lower-most price level. Thus, the price levels on the bid side may be ordered descending with regard to the associated limits. For the ask side 120, on the other hand, the best ask, i.e. the lowest limit a market participant is willing to sell a certain volume of contracts of the futures, may be merged into the top-most price level 125-1. The contracts associated with the highest limit a market participant is willing to sell a certain volume of contracts of the futures may be merged into the lower-most price level. Accordingly, the price levels on the ask side may be ordered ascending with regard to the associated limits. The orders listed in the top-most price levels of the bid and ask side may also be referred to as price best orders of the bid and ask side.

As explained above, during the continuous trading phase, i.e. when the order book 100 is opened, the order book 100 is always uncrossed, i.e. the best price level of the bid side is always lower than the best price level of the ask side. As an example and not limitation, FIG. 1 shows three price levels 115-1, 115-2 and 115-3 of the bid side 110 of order book 100, and four price levels 125-1, 125-2, 125-3 and 125-4 of the ask side 120 of order book 100. Each price level comprises at least one order. For instance, price level 115-1 comprises bid orders 130 and 135 and price level 125-1 comprises ask order 140. Each order in the order book 100 may be associated with a unique order ID, an order entry time, a limit and a volume. For instance, bid order 130 may be associated with the order ID “IT72”, the order entry time “10:49”, the volume “15” and the bid limit of “99.0”. Accordingly, the price level 130 may be associated with the limit “99.0”.

The orders in one price level may further be ordered by their respective entry times or by their associated quantities (ascending or descending). In the example of FIG. 1, the orders of each price level are ordered ascending with regard to their respective entry times. Accordingly, the order of execution of orders within a price level may be based on their respective entry times and/or their respective quantities

As indicated above, the present invention relates to trading a first futures contract, also referred to as a basis futures contract or basis futures, whose underlying asset is a second futures contract. In an embodiment, the underlying asset of the basis futures contract may be any futures contract traded at an exchange such as an equity index futures, a fixed income futures or a commodity futures. The basis futures contract may have an own product ID at the exchange as a different matching and settlement may be required than for other standard futures products.

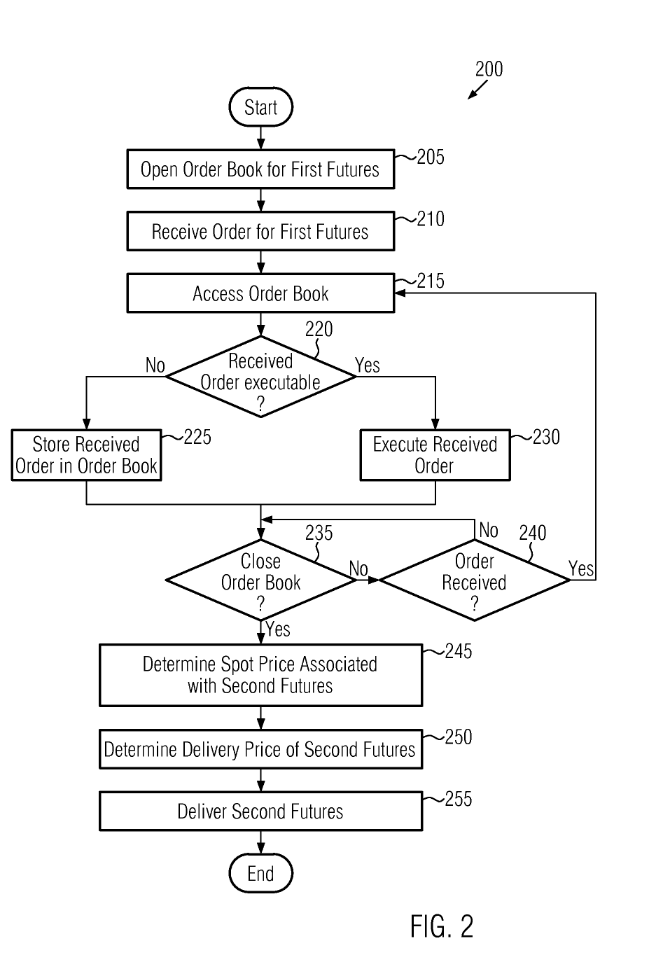

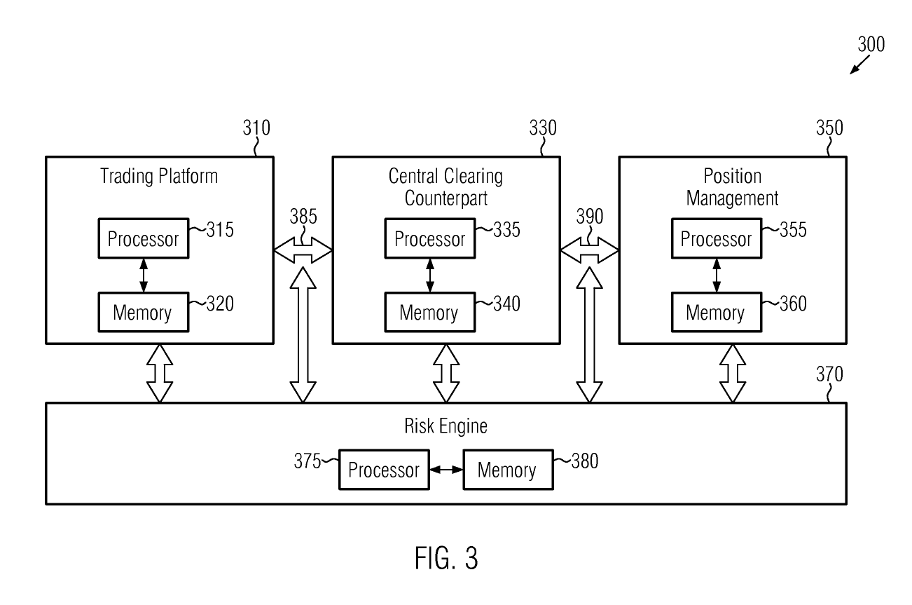

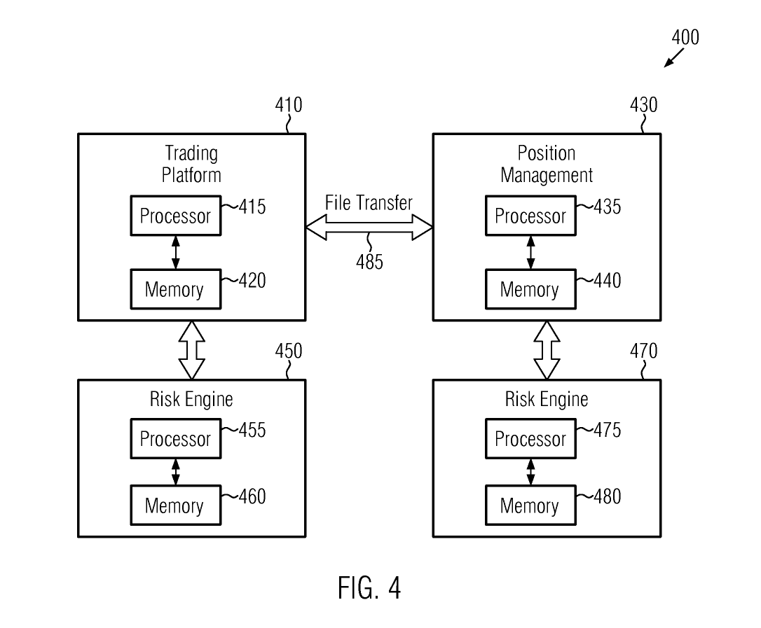

Referring now to FIG. 2, a computer implemented method for trading basis futures contracts is described. In the method described with regard to FIG. 2 and the systems described with regard to FIGS. 3 to 4, basis futures contracts may also be referred to as first futures contracts and the underlying assets of the basis futures contracts may be referred to as second futures contracts as indicated above.

Trading of derivatives products such as futures contracts may start at a point in time and end at another point in time. For instance, the trading may start at 8:00 am and may end at 5:30 pm. In the time period between the start of trading and the end of trading, i.e. the continuous trading phase, order book trades for the basis futures contracts may be carried out. Additionally, during the continuous trading phase, bilateral agreements between market participants in over-the-counter trades may also be performed.

There may be a further time period after the continuous trading phase called post trading phase. The post trading phase may, for instance, start at the point in time where the continuous trading phase ends. An exemplary end of the post trading phase may, for instance, be 10:30 pm. During the post trading phase, settlement may take place. Further, the calculation of the delivery price of the underlying second futures contracts and the physical delivery of the second futures contracts may take place.

In particular, at step 205, an order book for the first futures contracts may be opened. This may be done, for instance, at the start of the trading day at an exchange. The order book opened has stored orders for first future contracts. Each order stored in the opened order book defines a quantity of first futures contracts and a price of first futures contracts as explained above with regard to FIG. 1.

At step 210, an order (incoming order) for first futures contracts is received. This order may define a quantity of first futures contracts and a price for first futures contracts.

At step 215, the order book is accessed to determine if the order received at 210 is executable against a side of the order book. If the order received at 210 is executable, the order is executed against a side of the order book at step 230. If the order is not executable, the order received at step 210 is stored on a side in the order book at step 225.

Discussing steps 220, 225 and 230 in more detail, as explained above with reference to FIG. 1, the opened order book needs always to be uncrossed, i.e. the best price level of the bid side needs to be always lower than the best price level of the ask side.

Accordingly, if the order received at step 210 is a bid order, the price defined by this order is compared to the best price level of the ask side of the opened order book at step 220. If the price defined by the received bid order is greater than or equal to the best price level of the ask side, then the order is executable and is executed against the ask side at step 230. Similarly, if the order received at step 210 is an ask order, the price defined by this ask order is compared to the price of the best price level of the bid side at step 220. If the price defined by the ask order received in step 210 is lower than or equal to the best price level of the bid side, the order is executable and is executed at step 230 against the bid side of the order book.

If it is determined at step 220 that the order is not executable, the order is stored on the respective side of the order book.

According to some embodiments, if a received order has been determined to be executable against a side of the order book, but the quantity of the first futures contracts defined in the order received at step 210 is greater than the quantity of first futures contracts available for execution, the received order may be executed for available quantities and an order for the remaining not executed quantity of first futures contracts may be stored in the order book.

According to some embodiments, the storing of the received orders in the order book at step 225 may be done in a conventional manner. In particular, each order may be assigned an entry time and merged in a corresponding price level as explained above with reference to FIG. 1. The orders within a price level may be further ordered according to their entry times and/or quantities as explained above.

At step 235, it may be determined if the end of the trading day has been arrived. If the end of the trading day has not been arrived, it may be determined at step 240 if a further order has been received. If no further order has been received, the method may go back to step 235 for checking if the end of the trading day has been arrived. If, however, another order has been received, the method branches back to step 215 where the order book is accessed to determine if the order received at step 240 can be executed against a side of the order book.

Thus, steps 205 to 240 maintain an order book having orders for first futures contracts and determine if a received order for first futures contracts is executable against a side of the order book, wherein an underlying of a first futures contract is a second futures contract and wherein each order of the order book defines a quantity of the first futures contracts and a price of the first futures contracts.

If it is determined at step 235 that the end of the trading day has arrived, the order book is closed and a spot price associated with the second futures contracts is determined at 245.

According to embodiments of the present invention, the spot price associated with the second futures contracts determined at step 245 may be the price of the underlying of the second futures contracts at a specific point in time during the trading day. For instance, the spot price in those embodiments may be the price of the underlying of the second futures contracts at the index close of the underlying of the second futures contracts. As explained above, the underlying of the second futures contracts may be any asset such as, but not limited to, a security, a bond, a currency, an equity index, a fixed income, a commodity or any other underlying.

According to alternative embodiments of the present invention, the spot price associated with the second futures contracts determined at step 245 may be the futures price of the second futures at a specific point in time during the trading day. For instance, the spot price in those embodiments may be the futures price of the second futures at the closing of the continuous trading phase of the second futures.

At step 250, for each executed received order, a delivery price of the second futures contracts underlying the first futures contracts may be determined. For each executed order, this may be done by adding the price defined by the executed order to the spot price associated with the second futures contracts determined at step 245. In this regard, the price for the first futures contracts may be positive or negative. In some embodiments, no negative prices for the first futures contracts may be allowed. In cases where no negative prices are allowed, a certain predetermined price may be subtracted from the price of the first futures contract when calculating the price of the second futures contracts.

To give a more complete understanding of step 250, some exemplary scenarios for determining the delivery price for the second futures contracts are discussed which are not meant to be limiting:

### Example 1

Negative prices for the first futures contracts are allowed and the spot price associated with the second futures contracts is the price of the underlying of the second futures contracts at Index close:
The delivery price for the second futures contracts underlying the basis futures contracts may be determined by:

Basis futures price+Index close price of underlying of second futures=Delivery price of second futures

Index close of underlying of second futures: 2,485.62
Deliverable second futures: FESX (Euro Stoxx 50 Index Futures)
Member A: Long Basis Futures on FESX traded@3.00
Delivery Price: 2,488.62=3.00+2,485.62
Long 1 contract FESX
   Member B: Short Basis Futures on FESX traded@3.00
Delivery price: 2,488.62=3.00+2,485.62
Short 1 contract FESX
   Member C: Long Basis Futures on FESX traded@−2.00
Delivery price: 2,483.62=−2.00+2,485.62
Long 1 contract FESX
   Member D: Short Basis Futures on FESX traded at@−2.00
Delivery price: 2,483.62=−2.00+2,485.62
Short 1 contract FESX

### Example 2

Negative prices for the first futures contracts are not allowed and the spot price associated with the second futures contracts is the price of the underlying of the second futures contracts at Index close:

The delivery price for the second futures contracts underlying the basis futures contracts may be determined by:

(Basis futures price−100)+Index close price of underlying of second futures=Delivery price of second futures

Index close of underlying of second futures: 2,485.62
Deliverable second futures: FESX
Member A: Long Basis Futures on FESX traded@103.00
Delivery price: 2,488.62=103.00−100+2,485.62
Long 1 contract FESX
   Member B: Short Basis Futures on FESX traded@103.00
Delivery price: 2,488.62=103.00−100+2,485.62
Short 1 contract FESX
   Member C. Long Basis Futures FESX traded@98.00
Delivery price: 2,483.62=98.00−100+2,485.62
Long 1 contract FESX
   Member D: Short Basis Futures FESX traded@98.00
Delivery price: 2,483.62=98.00−100+2,485.62
Short 1 contract FESX

Referring back to FIG. 2, at step 255, the second futures contracts may be physically delivered based on the delivery price determined at 250 and the quantity of the first futures contracts defined by the executed order.

Discussing the characteristics of the basis futures contracts in more detail, the basis futures may be daily futures. A daily futures is defined as a futures contract which expires at the end of the trading day. According to an embodiment, the basis futures may be a daily futures with up to five expirations tradable at one point of time.

For the basis futures contracts, it is important that only one product ID is used, thus the basis futures contract is rolling. Rolling a contract means trading out of a contract and then buying the contract with the next longest maturity, so as to maintain a position with constant maturity.

As indicated above, the basis futures may be a daily futures which expires at the end of the trading day. According to some embodiments, several maturities should be possible to trade for daily basis futures. This is important for certain underlying futures contracts for which the determination of the final index close takes longer. This is typically the case for global indices like the MSCI World. However, the minimum requirement would be to have at least one daily futures series on a given trading day. The introduction of new maturities may take place on the next trading day (the same as the process for monthly/quarterly futures).

According to some embodiments, listed daily basis futures may have the following settlement options: settlement of front month futures or settlement of second month quarter.

As explained with regard to FIG. 2, the price of a second futures contract may be the sum of the price for the basis futures contract and the spot price of the underlying index of the second futures. Accordingly, the traded prices do not represent the final prices for delivery as the final price will not be determined before settlement.

In addition to order book trading, over-the-counter (OTC) wholesale functionality can take place concurrently. For OTC trades, a buyer has to enter the trade parameter of the agreed basis futures trade and a seller has to acknowledge the trade. For OTC trades, the minimum OTC block trade size for basis futures must be met. The trade may be immediately entered into OTC block trade after the bilateral agreement has been concluded. However, no aggregation of orders with different beneficial orders is possible.

The trading in basis futures contracts may take place until the index close price of the underlying of the second futures is determined.

Discussing the delivery of the second futures contracts in step 255 in more detail, at settlement, for all executed orders, the related underlying second futures contracts may be physically delivered at the delivery price. To this, a long position in the first futures will create a long position in the underlying second futures. Similarly, a short position in the first futures will create a short position in the second futures.

The position in the underlying second futures may be created the same day immediately after settlement. This is important in terms of trade reporting to the client. Further, the transaction ID of the basis futures trade should be transmitted to allow tracking of the TAIC.

For certain products for which the index close price will be published after the regular deadline for physical delivery, the settlement may take place the following clearing day.

As an alternative to step 255, all trades (executed orders) could be captured at the end of the trading day and then transformed into trades of the underlying second futures by using a trading on behalf functionality. As such, at the end of the trading day, the basis futures would not be going into settlement. Instead, the entered trades would be captured and the delivery price would be calculated. Finally, the underlying second futures would be automatically entered, e.g. uploaded, into an OTC block facility with market supervision privileges.

Accordingly, in this alternative to step 255, a trade having a trade price and a trade quantity would be created, wherein the trade price may be the delivery price determined at step 250 and the trade quantity may be the quantity of the second futures contracts resulting from the first quantity defined by the executed order. Then, the trade may be acknowledged by the participating parties and may be entered into an over the counter block trade facility

In conventional trading techniques, all futures products settle at the same price. For basis futures as discussed above, the final price must be determined on an individual level resulting in a plurality of different prices at which the underlying second futures will be delivered.

Discussing now technical processes for delivering the second futures in step 255 and referring to FIGS. 3 and 4, in FIG. 3, the second futures contracts are delivered by using a central clearing counterpart 330 (CCP). The CCP has one or more processors 335 which are coupled to a memory 340.

According to an embodiment, a trading platform 310 having one or more computer processors 315 coupled to a memory 320 is configured to perform steps 205 to 250 of FIG. 2. Thus, the trading of the first futures may take place on the trading platform 310. Step 255 may be performed by the trading platform 310, the CCP 330 and a position management system 350 in combination. In particular, at the end of the trading day, the net position of the first futures contracts may be delivered from the trading platform 310 to the CCP 330 to create delivery instructions for settlement of the first futures contracts into the underlying second futures contracts. The CCP 330 may transmit the delivery instructions to the position management system 350 which has one or more processors 355 coupled to a memory 360. The positions may be created in the underlying second futures contracts in the position management system 350 based on the delivery instructions.

As discussed above, according to an embodiment, steps 245 and 250 may be performed by the trading platform 310. According to an alternative embodiment, steps 245 and 250 may be performed by the CCP 330. According to yet another embodiment, steps 245 and 250 may be performed by the position management system 350 when the position is created in the position management system 350.

In some embodiments, the system 300 of FIG. 3 may additionally comprise a risk engine 370 having one or more processors 375 and a memory 380. The risk engine 370 may calculate the risk of the position in real time during the whole delivery process. In particular, the risk engine 370 may calculate the risk of the delivery process 385 when the trading platform 310 delivers the first futures contracts to the CCP 330 and of the transmission process 390 when the CCP 330 transmits the delivery instructions to the position management system 350.

Referring now to FIG. 4, according to an alternative embodiment, no CCP is used for delivery of the underlying second futures contracts. In this embodiment, the trading platform 410 having one or more computer processors 415 and a memory 420 creates a data file which is enriched with a final trade price and the net positions. The final trade price may, for instance, be the delivery price determined at step 250 and the net positions may, for instance, be a quantity defined by an executed order. Accordingly, the trading platform 410 may be configured to perform steps 205 to 250 of method 200.

The created file is transferred via communication line 485 to the position management system 430 which comprises one or more processors 435 and a memory 440. The position management system 430 creates a position of the second futures contracts based on the final trade price and the net position in the data file. Hence, the trading platform 410 and the position management system 430 perform step 255.

The system 400 may further include two risk engines 450 and 470. Each of the risk engines 450 and 470 may comprise a respective memory 460 and 480 and respective one or more processors 455 and 475. During the file transfer 485, no risk management is possible as no position exists. Thus, the risk engines 450 and 470 cannot calculate a risk during the file transfer, but only during trading in the trading platform 410 and during position creation in the position management system 470.

While the invention has been described with respect to the physical embodiments constructed in accordance herewith, it will be apparent to those skilled in the art that various modifications, variations and improvements of the present invention may be made in the light of the above teachings and within the purview of the appended claims without departing from the spirit and intended scope of the invention. Accordingly, it is to be understood that the invention is not limited by the specific illustrative embodiments, but only by the scope of the appended claims.

1. A computer-implemented method executed by one or more computing devices for trading first futures contracts, an underlying of a first futures contract being a second futures contract, comprising:
opening an order book having orders for the first futures contracts, wherein each order of the order book defines a quantity of the first futures contracts and a price of the first futures contracts;
receiving a first order for the first futures contracts, the first order defining a first quantity of the first futures contracts and a first price of the first futures contracts;
accessing the order book to determine if the first order is executable against a side of the order book;
if the first order is not executable, storing the first order in a side of the order book;
if the first order is executable:
executing the first order against a side of the order book;
determining a spot price associated with the second futures contracts; and
determining a delivery price of the second futures contracts, the delivery price being based on the spot price and the first price defined by the executed first order.

2. The computer-implemented method of claim 1, wherein the first futures contracts are daily futures contracts, the method further comprising:
closing the order book;
after closing the order book, delivering, at the delivery price, a quantity of the second futures contracts resulting from the first quantity defined by the executed first order to a participant having issued the first order.

3. The computer-implemented method of claim 2, wherein the delivery of the quantity of the second futures contracts is done on a same day the order book is closed if the spot price is determined before a daily deadline for delivery of the quantity of the second futures contracts and wherein the delivery of the quantity of the second futures contracts is done on a day after the day the order book is closed if the spot price is determined after the daily deadline for delivery of the quantity of the second futures contracts.

4. The computer-implemented method of claim 1, wherein the spot price associated with the second futures contracts is one of a price of the underlying of the second futures contracts at a point in time during a trading day and a price of the second futures contracts at a point in time during a trading day.

5. The computer-implemented method of claim 1, further comprising:
creating a trade having a trade price and a trade quantity, the trade price being the determined delivery price and the trade quantity being a quantity of the second futures contracts resulting from the first quantity defined by the executed first order;
acknowledging the trade; and
entering the trade into a over the counter (OTC) block trade facility.

6. The computer-implemented method of claim 1, further comprising:
delivering the first quantity of the first futures contracts defined by the executed first order to a central clearing counterpart to create delivery instructions for a position management system for settlement of the first futures contracts into the underlying second futures contracts based on the first quantity of the first futures contracts.

7. The computer-implemented method of claim 6, further comprising:
sending the delivery instructions to the position management system;
creating a position in the position management system of the second futures contracts based on the delivery instructions; and
calculating a risk in real time associated with delivering the quantity of the first futures contracts defined by the executed first order to the central clearing counterpart and associated with sending the delivery instructions to the position management system.

8. The computer-implemented method of claim 1, wherein the first price defined by the first order is one of a positive price and a negative price.

9. A system comprising:
a trading platform having one or more processors and a memory operatively coupled to the one or more processors, the memory storing instructions that, when executed by the one or more processors, cause the one or more processors to:
open an order book having orders for first futures contracts, an underlying of a first futures contract being a second futures contract, wherein each order of the order book defines a quantity of the first futures contracts and a price of the first futures contracts;
receive a first order for the first futures contracts, the first order defining a first quantity of the first futures contracts and a first price of the first futures contracts;
access the order book to determine if the first order is executable against a side of the order book;
if the first order is not executable, store the first order in a side of the order book;
if the first order is executable:
execute the first order against a side of the order book;
determine a spot price associated with the second futures contracts; and
determine a delivery price of the second futures contracts, the delivery price being based on the spot price and the first price defined by the executed first order.

10. The system of claim 9, further comprising a central clearing counterpart and a position management system, wherein:
the memory of the trading platform stores further instructions that cause the one or more processors of the trading platform to deliver the first quantity of the first futures contracts defined by the executed first order to the central clearing counterpart;
the central clearing counterpart has one or more processors and a memory operatively coupled to the one or more processors of the central clearing counterpart, the memory of the central clearing counterpart storing instructions that, when executed by the one or more processors of the central clearing counterpart, cause the one or more processors of the central clearing counterpart to create delivery instructions for settlement of the first futures contracts into the underlying second futures contracts based on the first quantity of the first futures contracts and to send the delivery instructions to the position management system; and
the position management system has one or more processors and a memory operatively coupled to the one or more processors of the position management system, the memory of the position management system storing instructions that, when executed by the one or more processors of the position management system, cause the one or more processors of the position management system to receive the delivery instructions and to create a position of the second futures contracts based on the delivery instructions.

11. The system of claim 10, further comprising a risk engine having one or more processors and a memory operatively coupled to the one or more processors of the risk engine, the memory of the risk engine storing instructions that, when executed by the one or more processors of the risk engine, cause the one or more processors of the risk engine to calculate a risk in real time associated with delivering the quantity of the first futures contracts defined by the executed first order to the central clearing counterpart and associated with sending the delivery instructions to the position management system.

12. The system of claim 9, further comprising a position management system, wherein:
the memory of the trading platform stores further instructions that cause the one or more processors of the trading platform to create a file comprising the delivery price and a quantity of the second futures contracts resulting from the first quantity defined by the executed first order and to send the file to the position management system; and
the position management system has one or more processors and a memory operatively coupled to the one or more processors of the position management system, the memory of the position management system storing instructions that, when executed by the one or more processors of the position management system, cause the one or more processors of the position management system to receive the file and to create a position of the second futures contracts based on the delivery price and the quantity of the second futures contracts.

13. A computer-readable medium having stored computer-executable instructions that, when executed by a computer, cause the computer to:
maintain an order book having orders for first futures contracts, an underlying of a first futures contract being a second futures contract, wherein each order of the order book defines a quantity of the first futures contracts and a price of the first futures contracts to determine if a first order for a first futures contracts is executable against a side of the order book; and
determine a delivery price of the second futures contracts based on a spot price associated with the second futures contracts and a determined price of the first futures contracts.

14. The computer-readable medium of claim 13, wherein maintaining the order book comprises:
opening the order book;
receiving a first order for the first futures contracts, the first order defining a first quantity of the first futures contracts and a first price of the first futures contracts;
accessing the order book to determine if the first order is executable against a side of the order book;
if the first order is not executable, storing the first order in a side of the order book; and
if the first order is executable, executing the first order against a side of the order book,
wherein the determined price of the first futures contracts is the first price defined by the executed first order.

15. The computer-readable medium of claim 13, wherein the computer-readable medium further comprises instructions that cause the computer to:
create a trade having a trade price and a trade quantity, the trade price being the determined delivery price and the trade quantity being a quantity of the second futures contracts resulting from the first quantity defined by the executed first order;
acknowledge the trade; and
enter the trade into a over the counter (OTC) block trade facility.
